(19) United States
(12) Patent Application Publication
(10) Pub. No.: US 2009/0127267 A1
(43) Pub. Date: May 21, 2009

(54) COOKING UTENSIL

(76) Inventor: Amaury Bhagat, Paris (FR)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/995,485

(22) PCT Filed: Jul. 12, 2006
(86) PCT No.: PCT/FR06/01706

§ 371 Date: Jan. 8, 2009

(30) Foreign Application Priority Data
Jul. 12, 2005 (FR) 0552166

(51) Int. Cl. A47J 27/00; B21D 39/00

(52) U.S. Cl. 220/573.1; 29/505

(57) ABSTRACT

The invention relates to a cooking utensil (1) comprising a container (2) and a base (3) made from stainless steel, said base being equipped with perforations (6). According to the invention, the base (3) is fitted to the exterior of the bottom. of the container (2), such that the perforations (6) are filled with the, material that forms the container (2). The wall of the container (2) is formed by stacking a layer of stainless steel (4) and a layer of aluminium (2), said aluminium (2) filling the perforations in the base (3).

Cooking utensils constituted of a container comprising an internal stainless steel plate and an external aluminium plate, are known. However, the aluminium plate is deformable under the action of the heat source and aluminium does not have the electromagnetic properties enabling such utensil to be induction-heated.

Cooking utensils constituted of a container comprising an internal aluminium plate and an external stainless steel plate, are also known. Such cooking utensils make an induction-heating possible. However, the internal aluminium plate must be coated with a food grade coatings Besides, the thermal conductivity of stainless steel is lower than that of aluminium. Thus, the thermal conductivity of such type of utensil is not optimized for an utilization on a gas stove.

Besides, in patent FR 2 801 485, is described a cooking utensil constituted of a container comprising a base comprising an interlayer plate made of aluminium and an external perforated plate made of stainless steel, said plate is fitted into the aluminium plate, such that the perforations of the external plate are filled with the aluminium of the interlayer plate. Thus, the aluminium plate is reinforced by the external plate, and the utensil can be induction-heated. However, the thermal conductivity of the cooking utensil is not optimized, since aluminium is coated only on the base of the container.

The present invention aims at remedying such problems by providing a cooking utensil which can be used on a gas stove as well as on an induction plate, having a very good thermal conductivity for an optimal use on a gas stove and being quite simple to manufacture.

For this purpose and according to a first aspect, the invention provides a cooking utensil comprising a container and a base made of stainless steel and being equipped with perforations; said base being fitted to the exterior of the bottom of the container such that the perforations are filled with the material that forms the container, the cooking utensil being characterized in that the wall of the container is formed by stacking a layer of stainless steel and a layer of aluminium, the aluminium filling the perforations in the base.

Thus, the utensil is equipped with a base made of magnetic stainless steel making it possible to use it on induction systems and the aluminium of the container which fills the perforations allows good heat conduction during the utilization on a gas stove.

Besides, the layer of aluminium is coated on the whole container, which makes it possible to propagate rapidly the heat to the whole of the container.

Finally, the layer of stainless steel in the container enables a good preservation of heat inside the container.

Other objects and advantages of the invention will appear evident when reading the following description which is made while referring to the appended drawings, wherein:

FIG. 1 shows a cross-sectional view of a cooking utensil according to the invention,

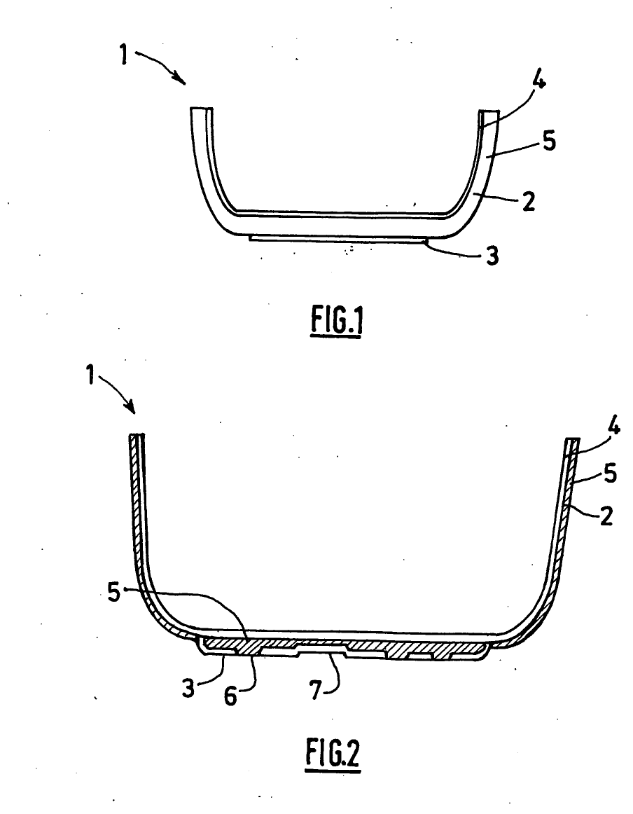

FIG. 2 shows a cross-sectional view of a cooking utensil according to the invention, more precisely illustrating the base of such utensil;

FIG. 3 shows a bottom view of such a utensil;

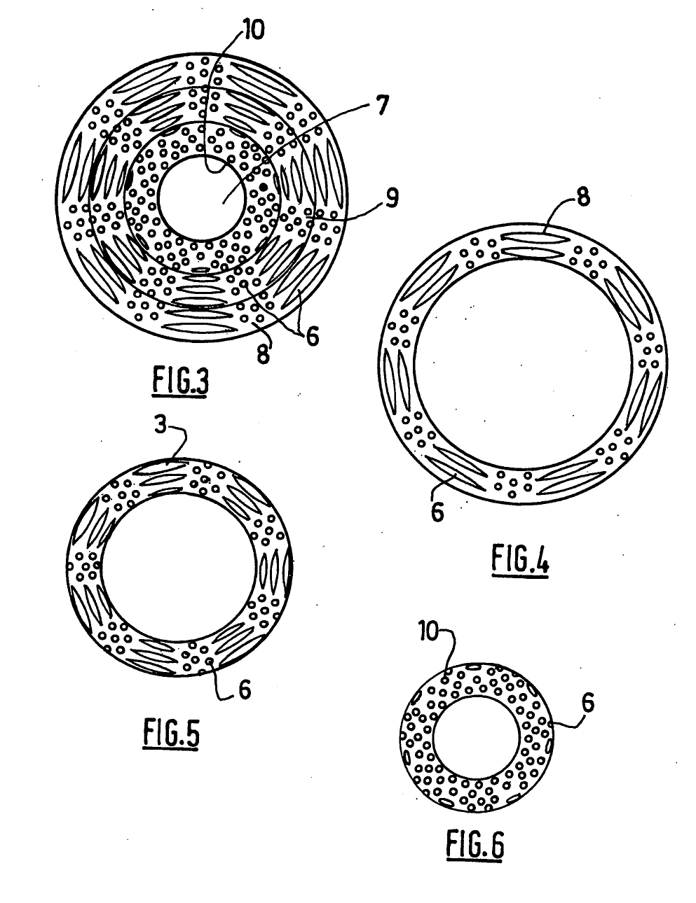

FIG. 4 to 6 show views of the three successive annular areas.

A cooking utensil 1 comprises a container 2 and a base 3 made of stainless steel and equipped with perforations 6.

The wall of the container 2 is formed by stacking a layer of stainless steel 4 and a layer of aluminium 5. The production of such container is performed by simultaneously pressing both layers 4, 5. A layer of aluminium 5 forms the exterior of the wall of the container 2 and the layer of stainless steel 4 forms the interior of the wall of the container 2. In one embodiment of the invention, the layer of aluminium 5 has a thickness comprised between 3 and 5 mm and the thickness of the layer of stainless steel 4 is comprised between 0.5 and 1 mm. In one embodiment, the layer of stainless steel 4 of the container 2 is polished.

The stainless steel base 3 is applied onto the external bottom of the container 2 by a hot press exerting a pressure of 2,000 tons. Thus, aluminium fills the perforations 6 of the base 3 and the thermal conductivity of the cooking utensil 1 is enhanced. In the preferred embodiment of the invention, aluminium is flush with the perforations 6.

The base 3, for example, has a section of 200 mm and a thickness comprised between 0.5 and 1 mm.

In one embodiment of the invention, the base 3 has a recessed central area 7. Thus, the revolving drum effect which occurs in case of a deformation of the base 3 is avoided.

In a preferred embodiment, the central area 7 is pressed, thus forming a recess of approximately 1 mm, with a section of 50 mm. Such a recession is formed by pressing, which causes aluminium to creep towards the peripheral areas. The pressing of the central area 7 makes it possible to prevent the blistering of the base caused by air trapped between the container 2 and the base 3.

According to an advantageous embodiment, the diameter of the pressed central area 7 is equal to approximately one quarter of the diameter of the base 3.

The central area 7 is enclosed by a perforated area comprising round perforations and elliptic perforations. Preferably, the diameter of round perforations is less than 0.015 times the diameter of the base.

If the density and the gradient of density are critical, the particular shape and the distribution of the perforations may cause many variations mainly guided by aesthetic considerations. However and preferably, the diameter of the biggest perforation is lower than 0.8% of the bottom surface.

The first annular area 8 enclosed in the central area 7 is mainly fitted with round perforations having a diameter of 2.6 mm each, as well as elliptic perforations the smaller axis of which approximately 2.3 mm and the bigger axis of which measures approximately 10 mm, Such first annular area 8 comprises 77 round perforations and 7 elliptic perforations. It has an external section of 84 mm. The density of perforations is approximately 10.77% in this first area. Preferably, such annular area has an external diameter comprised between 0.4 and 0.5 times the diameter of the base.

The middle annular area 9 has a density of perforations of approximately 24.77%. It includes 3 concentric circular rows comprising, each, 7 elliptic perforations of increasing sizes. Between two angular sectors of three radially aligned elliptic perforations, such middle area 9 has an assembly of 7 round perforations, 2.6 mm in section.

Such middle area 9 thus includes 21 elliptic perforations and 49 round perforations. The elliptic perforations have smaller axes respectively measuring 3.2 mm, 3.7 mm and 3.8 mm and bigger axes respectively measuring 23 mm, 30 mm and 36 mm. According to a preferred embodiment, the middle annular area 9 has an external diameter comprised between 0.7 and 0.8 times the diameter of the base 3.

The third annular area 8 also has 3 concentric circular rows, each comprising 7 elliptic perforations of increasing sizes between two angular sectors of three radially aligned elliptic perforations. The elliptic perforations have smaller axes respectively measuring 4 mm, 4.2 mm and 4.2 mm and bigger axes respectively measuring 42 mm, 47 mm and 50 mm. The density of perforations of such peripheral area 8 is approximately 21%.

It should be noted that it is essential to comply with the characteristics relating to the density of perforations 6.

Thus, in order to secure an efficient transmission of heat during utilization with a gas stove, the density of perforations is greater than 15%. Advantageously, the density of perforations is greater than 20% and lower than 30%.

According to a preferred embodiment, the density of perforations is comprised between 5 and 15% in an annular band 10 surrounding the central area, between 20 and 30% in the middle annular band 9 and between 15 and 25% in the external annular band B. According to a preferred embodiment, the maximum density is of the order of 25% in the middle annular area 9.

The base 3 according to the present invention is particularly adapted to heating by several types of gas stoves:
a gas stove producing a flame, the peak of which substantially corresponds to the middle annular area 9 when the flame is well adjusted;
an induction plate which excites the magnetic stainless steel base 3;
a glass-ceramic plate transmitting heat by convection mainly through the flushing aluminium areas.

The distribution of the perforations 6 is homogenous and more particularly no area over 10 or 15 mm in section is free of perforations 6.

In the present patent, “density of perforations” means the ratio of the cumulated surface of the perforations 6 formed in a reference area to the total surface of such reference area. The density of perforations 6 is null when the reference area has no perforation 6, and 100% if the reference area totally corresponds to one perforation 6.

Unless otherwise mentioned, the reference area corresponds to the total surface of the base of utensil 1, and the density of perforations 6 also corresponds to the ratio of the cumulated surface of perforations 6 to the total surface of the base 3.

“Aluminium” in the present patent means pure aluminium or an aluminium alloy usually employed to produce cooking utensils, because of its thermal characteristics.

1. (canceled)

2-11. (canceled)

12. A cooking utensil, comprising:
a container including an outer surface, an inner surface and a bottom portion, the outer surface being constructed at least in part from a layer of aluminum based material and the inner surface being constructed at least in part from a layer of stainless steel based material; and
a base constructed from a stainless steel based material and including at least one perforation;
wherein the base is fitted to the outer surface along the bottom portion of the container such that the at least one perforation is filled at least in part with the layer of aluminum based material from the container.

13. A cooking utensil as recited in claim 12, wherein the base includes a recessed central area.

14. A cooking utensil as recited in claim 13, wherein the recessed central area is formed by pressing the base.

15. A cooking utensil as recited in claim 12, wherein the base includes a plurality of perforations.

16. A cooking utensil as recited in claim 15 wherein the base includes a total base surface area and a perforation surface area, wherein the perforation surface area is defined by the cumulative surface of the perforations in the base, and the ratio of the perforation surface area to the total base surface area defines a density of perforations.

17. A cooking utensil as recited in claim 16, wherein the density of the perforations in the base is greater than approximately 15%.

18. A cooking utensil as recited in claim 16, wherein the density of the perforations in the base is greater than approximately 20%.

19. A cooking utensil as recited in claim 18, wherein the density of the perforations in the base is lower than approximately 30%.

20. A cooking utensil as recited in claim 16, wherein the density of perforations is between about 5% and about 15% in an annular band surrounding the central area, between about 20% and about 30% in a middle annular band and between about 15% and about 25% in an external annular band, wherein the middle annular band is surrounded by the annular band and the external annular band.

21. A cooking utensil as recited in claim 12, wherein the layer of aluminum based material includes a thickness that is between about 3 mm and about 5 mm.

22. A cooking utensil as recited in claim 12, wherein the base includes a thickness that is between about 0.5 mm and about 1 mm.

23. A cooking utensil as recited in claim 12, wherein the layer of stainless steel based material includes a thickness that is between about 0.5 mm and about 1 mm.

24. A cooking utensil as recited in claim 12, wherein the layer of stainless steel based material of the container is polished.

25. A method of making a cooking utensil, comprising the steps of:
stacking a layer of aluminum based material and a layer of stainless steel based material together to construct a container;
defining an outer surface and an inner surface of the container, the outer surface constructed at least in part from the layer of aluminum based material and the inner surface constructed at least in part from the layer of stainless steel based material;
pressing both of the layer of stainless steel based material and the layer of aluminum based material together;
applying a base to a bottom portion of the container, the base including at least one perforation and constructed from a stainless steel based material; and
filling the at least one perforation of the base at least in part with the layer of aluminum based material from the container.

26. The method as recited in claim 25, further comprising the step of forming a central recessed area in the base.

27. The method as recited in claim 26, wherein the central area is formed by pressing the base.

28. The method as recited in claim 25, further comprising the step of polishing the layer of stainless steel based material.
